(19) United States
(12) Patent Application Publication
(10) Pub. No.: US 2014/0119600 A1
(43) Pub. Date: May 1, 2014

(54) DETECTION APPARATUS, VIDEO DISPLAY SYSTEM AND DETECTION METHOD

(71) Applicant: Kabushiki Kaisha Toshiba, Tokyo (JP)

(72) Inventor: Emi MARUYAMA, Tokyo (JP)

(21) Appl. No.: 13/915,912

(22) Filed: Jun. 12, 2013

(30) Foreign Application Priority Data
Oct. 29, 2012 (JP) 2012-238106

(51) Int. Cl. G06K 9/00

(52) U.S. Cl. CPC G06K 9/00255
USPC 382/103

(57) ABSTRACT

According to one embodiment, a detection apparatus includes a detector and a detection area setting module. The detector is configured to detect a human face within a detection area which is a part of or a whole of an image captured by a camera, by varying a distance between the human face to be detected and the camera. The detection area setting module is configured to set the detection area narrower as the distance is longer.

### CROSS REFERENCE TO RELATED APPLICATIONS

This application is based upon and claims the benefit of priority from the prior Japanese Patent Application No. 2012-238106, filed on Oct. 29, 2012, the entire contents of which are incorporated herein by reference.

### FIELD

Embodiments described herein relate generally to a detection apparatus, a video display system and a detection method.

### BACKGROUND

In recent years, as display apparatuses become high definition, a display screen is often viewed from a position near the display apparatus. On the other hand, as display apparatuses become large, also a display screen is often viewed from a position away from the display apparatus. Therefore, different processing may be required depending on whether a viewer is near the display apparatus or away from the display apparatus. Thus, considering the convenience of the viewer, it is desirable that the position of the viewer is automatically detected.

### BRIEF DESCRIPTION OF THE DRAWINGS

FIGS. 1 to 3 are diagrams for explaining a face detection system according to a first embodiment.

FIG. 4 is a block diagram showing an internal configuration of the face detection apparatus 30.

FIGS. 5 and 6 are diagrams for specifically explaining the processing operation of the detection area setting module 32.

FIG. 7 is a diagram for explaining a manner for calculating the height H1.

FIG. 8 is an external view of a video display system.

FIG. 9 is a block diagram showing a schematic configuration the video display system.

FIGS. 10A to 10C are diagrams of a part of the display panel 11 and the lenticular lens 12 as seen from above.

FIG. 11 is a diagram schematically showing the viewing area.

FIG. 12 is a block diagram showing a schematic configuration the video display system, which is a modified example of FIG. 9.

### DETAILED DESCRIPTION

In general, according to one embodiment, a detection apparatus includes a detector and a detection area setting module. The detector is configured to detect a human face within a detection area which is a part of or a whole of an image captured by a camera, by varying a distance between the human face to be detected and the camera. The detection area setting module is configured to set the detection area narrower as the distance is longer.

Embodiments will now be explained with reference to the accompanying drawings.

### First Embodiment

FIGS. 1 to 3 are diagrams for explaining a face detection system according to a first embodiment. The face detection system includes a camera 20 and a face detection apparatus 30. The camera 20 is attached to a video display apparatus 10 including a display panel 11 for displaying video. The face detection apparatus 30 detects a human face from an image captured by the camera 20. Shaded areas and an area not shaded inside the shaded areas in FIG. 1 are captured by the camera 20. FIG. 1 shows an example in which a viewer A is at a position away from the video display apparatus 10 by a distance Z1 and viewers B and C are at a position away from the video display apparatus 10 by a distance Z2 (>Z1).

First, a general operation of the face detection system will be described.

The face detection apparatus 30 detects a human face away from the video display apparatus 10 by a distance Z (=Zmin to Zmax). More specifically, the face detection apparatus 30 detects a face of a viewer while changing the distance Z from the minimum value Zmin to the maximum value Zmax which are determined in advance. For example, when a face is detected at a distance Z0, it is known that the viewer is located at a position of the distance Z0.

The face detection apparatus 30 detects a human face at a height Y (=Ymin to Ymax) from the floor. This is because a face is rarely detected at near the floor or near the ceiling. The shaded areas in FIG. 1 are areas excluded from an area captured by the camera 20 as non-detection-target areas, because of the limitations of Ymin, Ymax, Zmin, and Zmax.

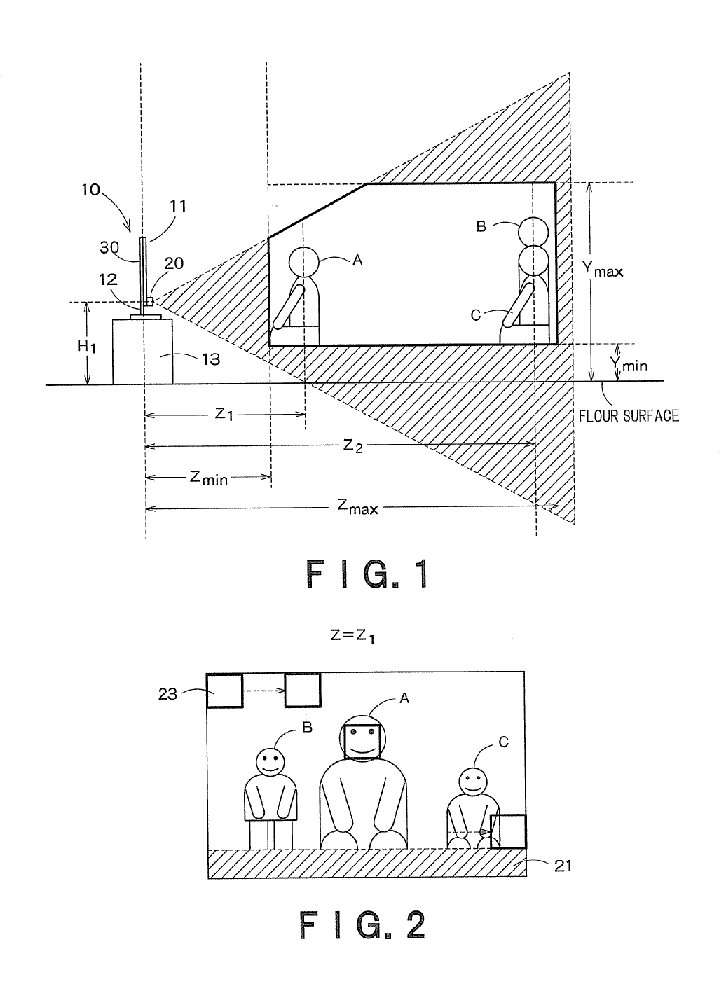

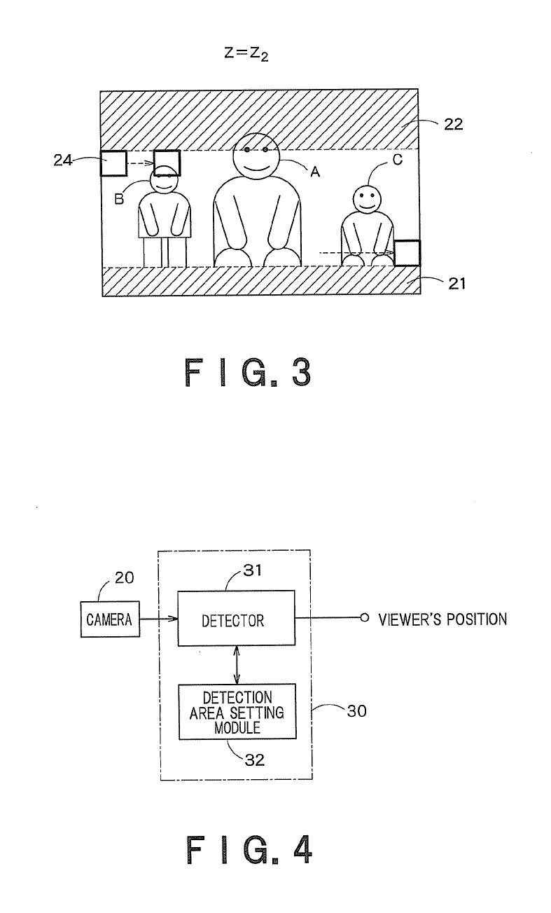

FIGS. 2 and 3 are images that will be captured by the camera 20 when the video display apparatus 10 and the viewers A, B, and C have the positional relationship shown in FIG. 1. Reference numerals 23 and 24 denote a detection window described later.

FIG. 2 shows a situation in which the distance Z is the relatively small Z1, that is, in which the face of the viewer near the video display apparatus 10 is detected. The possibility that a face is detected in a lower area 21 in an image captured by the camera 20 is low. This is because it is rare that a viewer is located very near to the floor, and usually the viewer views video displayed on the display panel 11 while the viewer sits down on the floor or a chair or the viewer stands up. Therefore, the face detection apparatus 30 does not perform a face detection process on the lower area 21 in the image captured by the camera 20.

On the other hand, in an area near the video display apparatus 10, the camera 20 does not capture an area in a relatively high position. Therefore, a face may be detected on an upper area in the image captured by the camera 20. Therefore, the face detection apparatus 30 performs the face detection process on the upper area in the image captured by the camera 20.

As a result, when the distance Z is small, as shown in FIG. 3, the face detection apparatus 30 performs face detection using the image captured by the camera 20 except for the lower area 21 as a detection area.

FIG. 3 shows a situation in which the distance Z is the relatively large Z2, that is, in which a face of a viewer away from the video display apparatus 10 is detected. In the same manner as in FIG. 2, the possibility that a face is detected in the lower area 21 in the image captured by the camera 20 is low. Therefore, the face detection apparatus 30 does not perform the face detection process on the lower area 21 in the image captured by the camera 20.

On the other hand, in an area away from the video display apparatus 10, the camera 20 captures an area in a position higher than the height of the viewer. Therefore, the possibility that a face is detected in an upper area 22 in the image captured by the camera 20 is low. Therefore, the face detection apparatus 30 does not perform the face detection process on the upper area 22 in the image captured by the camera 20.

As a result, when the distance Z is large, as shown in FIG. 3, the face detection apparatus 30 performs face detection using the image captured by the camera 20 except for the lower area 21 and the upper area 22 as a detection area.

In this way, by performing the face detection setting only the necessary area in the image captured by the camera 20 as the detection area, it is possible to reduce the processing load of the face detection apparatus 30.

Hereinafter, details of the configuration and the processing operation of the face detection system will be described. The face detection system includes the camera 20 and the face detection apparatus 30. A video display system includes the face detection system and the video display apparatus 10.

In FIG. 1, the camera 20 is attached on a bezel (not shown in FIG. 1) below the display panel 11. In the present embodiment, it is assumed that the “distance from the video display apparatus 10” and the “distance from the camera 20” are the same. It is assumed that the camera 20 includes an ideal lens which has no lens distortion and no shift of the optical axis. It is assumed that the optical axis of the camera is perpendicular to the display panel 11 and the horizontal direction of the image captured by the camera 20 and the floor surface are horizontal. Hereinafter, unless otherwise stated, it is assumed that the optical axis of the camera is a Z axis (+in an image display direction from the surface of the display panel 11), an axis perpendicular to the floor surface is a Y axis (+in a direction toward the ceiling), an axis in parallel with the floor surface and perpendicular to the Y axis is an X axis, and the display panel 11 is in parallel with an X-Y plane. Regarding attachment of the camera 20, it is simply referred to as “the camera 20 is oriented substantially in the horizontal direction”. The camera 20 is supplied power from the video display apparatus 10 and controlled by the video display apparatus 10.

The video display apparatus 10 is mounted on a TV pedestal 13 in a state in which the video display apparatus 10 is supported by a TV stand 12. It is assumed that the height of the camera 20 (more exactly, the lens of the camera 20) from the floor surface, that is, the surface with which the bottom of the TV pedestal 13 is in contact is H1. The height H1 includes the TV pedestal 13, the TV stand 12, and the width of the bezel. Of course, the video display apparatus 10 may be placed on the floor surface without using the TV pedestal 13. In this case, the height H1 has a value corresponds to the TV stand 12 and the width of the bezel.

The face detection apparatus 30 may be formed as one semiconductor integrated circuit that is integrated with a controller of the video display apparatus 10 or may be an apparatus separate from the controller. The face detection apparatus 30 may be configured by hardware or at least a part of the face detection apparatus 30 may be configured by software.

FIG. 4 is a block diagram showing an internal configuration of the face detection apparatus 30. The face detection apparatus 30 includes a detector 31 and a detection area setting module 32. The detector 31 detects a human face from the detection area in the image captured by the camera 20. The detection area setting module 32 sets a part or whole of the image captured by the camera 20 to the detection area according to the distance between the video display apparatus 10 and a viewer to be detected. Hereinafter, the face detection apparatus 30 will be more specifically described.

First, the detector 31 sets a size of a detection window according to the distance (hereinafter referred to as “detection distance”) Z between a viewer whose face is to be detected and the video display apparatus 10. The detection window is an area that is a unit of the face detection as shown in FIGS. 2 and 3, and the detector 31 determines the width of the detection window when the face is detected as a face width on the image.

The size of the detection window is set by estimating the average size of a human face. As the detection distance Z is greater, the size of the face in the image captured by the camera 20 becomes smaller. Therefore, as the distance Z is greater, the detection window is set smaller.

In the present embodiment, the detection window is a square with a side length w. A relationship between the side length w [pixels] of the detection window (word inside the [ ] indicates a unit, the same hereinafter) and the detection distance Z [cm] is represented by the following formula (1).

w=ave_{—}w*f_{H}/Z (1)

Here, f_{H} is a horizontal focal length [pixels] of the camera 20. Also here, ave_w [cm] is a predetermined value which corresponds to the average width of a human face. The minimum value Zmin and the maximum value Zmax of the detection distance Z are values estimated from the usage environment of the video display apparatus 10, and for example, 100 [cm] and 600 [cm], respectively.

When the detection window is set in the manner as described above, the detector 31 performs the face detection while moving the detection window from the upper left to the lower right in the order of raster scan in the detection area (setting manner will be described later) in the image captured by the camera 20. Although the manner of the face detection may be arbitrarily determined, for example, information indicating features of a face of a human, such as features of eyes, nose, and mouth of a human, is stored in advance and the detector 31 can determine that there is a face in the detection window when the features match features in the detection window.

For example, as shown in FIG. 2, the detector 31 determines that there is a face at the position of the viewer A while moving the detection window 23. The detector 31 acquires position coordinates of the detection window on an image plane when the face is detected and obtains Z1=ave_w*f_{H}/w1 from the length of a side length w1 of the detection window 23. Also, as shown in FIG. 3, the detector 31 determines that there is a face at the positions of the viewers B and C while moving the detection window 24. The detector 31 acquires position coordinates of the detection window 24 on the image plane when the face is detected and obtains Z2=ave_w*f_{H}/w2 from the length of a side length w2 of the detection window 24.

The detector 31 performs the face detection while changing the size w of the detection window in stages from a minimum length wmin (=ave_w*f_{H}/Zmax) corresponding to the maximum value Zmax to a maximum length wmax (=ave_w*f_{H}/Zmin) corresponding to the minimum value Zmin. Thereby, it is possible to detect a viewer away from the video display apparatus 10 by a distance from the minimum value Zmin to the maximum value Zmax.

When a human face is detected at the distance Z0, the detector 31 outputs the fact that there is a viewer at the position of the distance Z0 from the video display apparatus 10.

The detection area setting module 32 sets the detection area according to the detection distance Z, in other words, the size of the detection window. The greater the detection distance Z, in other words, the smaller the size of the detection window, the smaller the detection area is set.

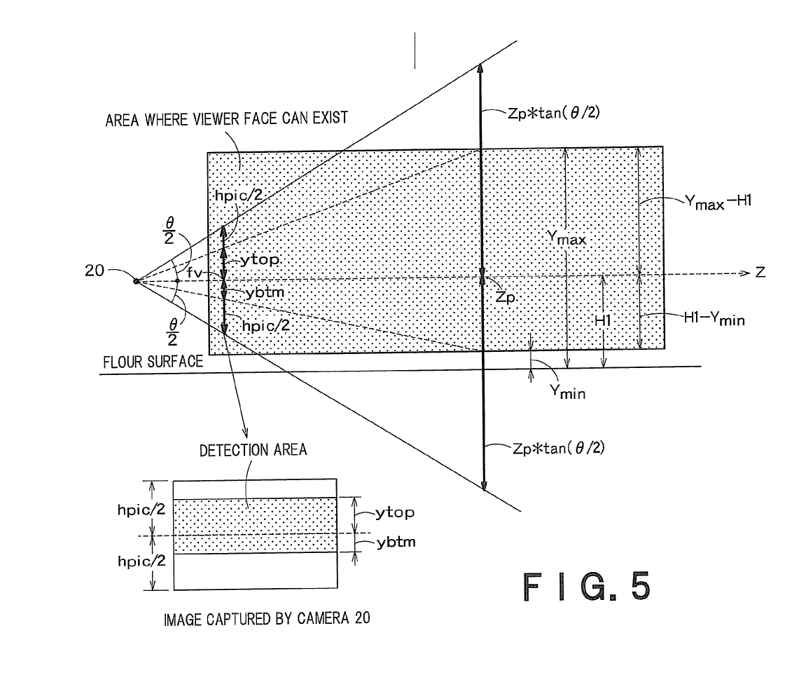

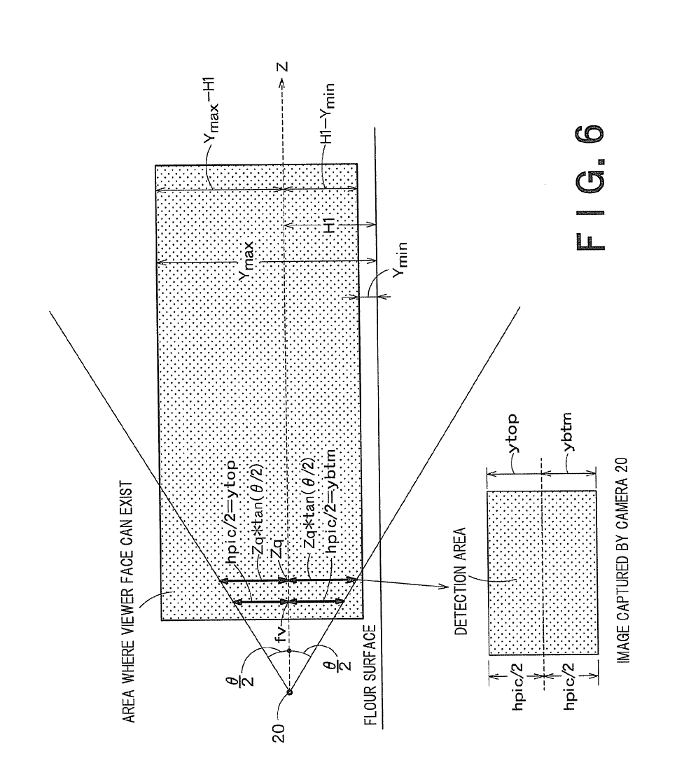

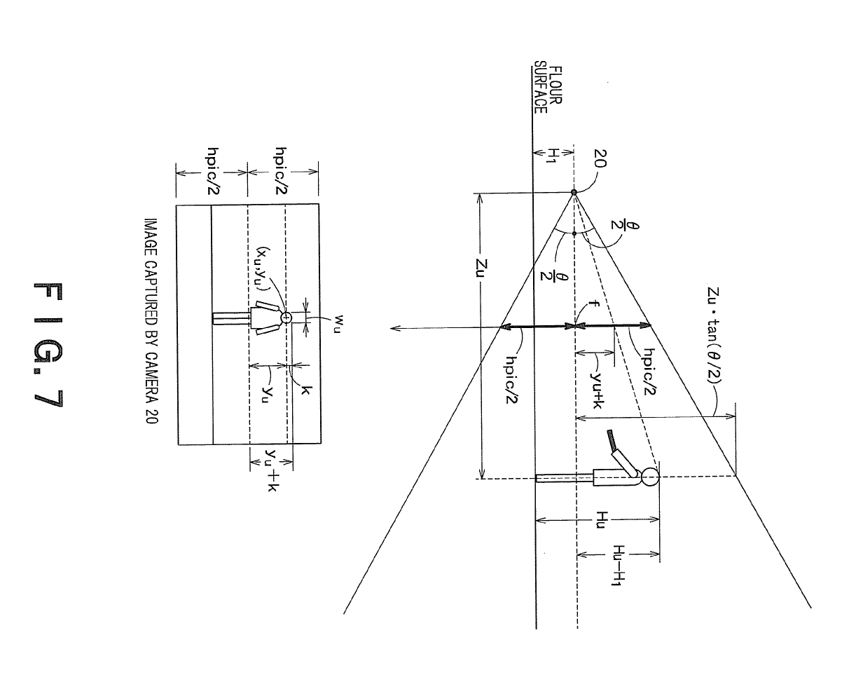

FIGS. 5 and 6 are diagrams for specifically explaining the processing operation of the detection area setting module 32. FIGS. 5 and 6 show a situation where images of objects at distances Zp and Zq, which are captured by the camera 20, are formed at a position of a vertical focal distance fᵥ [pixels]. The definition of parameters in FIGS. 5 and 6 is as follows:

Z(Zp, Zq): detection distance [cm]

H1: height of the camera 20 from the floor surface [cm]

Ymin: minimum value of the height at which a face of a viewer exists [cm]

Ymax: maximum value of the height at which a face of a viewer exists [cm]

θ: vertical angle of view of the camera 20 [rad]

hpic: the number of vertical pixels of an image captured by the camera 20 [pixels]

ytop: detection area in the upper half of the image captured by the camera 20 [pixels]

ybtm: detection area in the lower half of the image captured by the camera 20 [pixels]

As shown in FIGS. 5 and 6, the detection area is an area of the ytop [pixels] in the upper half and the ybtm [pixels] in the lower half of the image captured by the camera 20 in the vertical direction, in other words, an area obtained by removing the upper (hpic/2−ytop) [pixels] and the lower (hpic/2−ybtm) [pixels] from the image captured by the camera 20 in the vertical direction. Regarding the horizontal direction, the entire area is the detection area.

In the present embodiment, it is assumed that the height H1 is known. For example, a viewer may measure the height of the camera 20 from the floor surface and input the height into the face detection apparatus 30. Alternatively, a viewer inputs the height of the mounting surface (the height of the upper surface of the TV pedestal 13) from the floor surface, and the detection area setting module 32 may calculate the height H1 based on the inputted height in advance.

The minimum value Ymin of the height at which a face of a viewer exists is set to, for example, 50 [cm] by assuming that the viewer views the display screen while sitting on the floor. The maximum value Ymax of the height at which a face of a viewer exists is set to, for example, 200 [cm] by assuming that the viewer views the display screen while standing up.

The vertical angle of view θ and the number of vertical pixels hpic are constants determined by the performance and/or setting of the camera 20.

Therefore, H1, Ymin, Ymax, θ, and hpic are known values or constants. The detection area setting module 32 sets the detection areas ytop and ybtm as a function of the detection distance Z based on these parameters.

First, the detection area ytop will be described. It is assumed that the camera is oriented substantially in the horizontal direction. When the detection distance is Z [cm], the height of the upper half of the image captured by the camera 20 is Z*tan(θ/2) [cm]. On the other hand, in an area higher than the height H1, a face of a viewer can exist in an area of (Ymax−H1) [cm] or less.

Therefore, when the formula (2) below is satisfied as in the case of Z=Zq shown in FIG. 6, a face of a viewer may exist in the entire area of the upper half of the image captured by the camera 20.

Ymax−H1>Z*tan(θ/2) (2)

Therefore, when the detection distance Z satisfies the formula (3) derived from the above formula (2), the detection area setting module 32 sets the entire area of the upper half of the image captured by the camera 20 to the detection area ytop as shown by the formula (4) below.

Z<(Ymax−H1)/tan(θ/2) (3)

ytop=hpic/2 (4)

On the other hand, when the above formula (2) is not satisfied as in the case of Z=Zp shown in FIG. 5, the camera 20 captures an image upper than an area in which a face of a viewer can exist. In this case, the area in which a face of a viewer can exist is ytop [pixels] among the number of pixels hpic/2 [pixels] of the upper half of the image captured by the camera 20. On the other hand, the area in which a face of a viewer can exist is (Ymax−H1) [cm] among the height Z*tan(θ/2) [cm] in which an image is captured by the camera 20. Therefore, the proportional relationship indicated by the formula (5) below is established.

hpic/2:ytop=Z*tan(θ/2):Ymax−H1 (5)

Therefore, if the above formula (2) is not satisfied, the formula (6) below is derived.

$$ytop = \frac{hpic}{2} * \frac{Y max - H 1}{Z * tan θ / 2} \qquad ( 6 )$$

In summary, the detection area setting module 32 sets the detection area ytop as indicated by the formula (7) below.

$$\begin{matrix}ytop = \frac{hpic}{2} & ( for Z < \frac{Y max - H 1}{tan θ / 2} ) \\ = \frac{hpic}{2} * \frac{Y max - H 1}{Z * tan θ / 2} & ( for Z \geq \frac{Y max - H 1}{tan θ / 2} )\end{matrix} \qquad ( 7 )$$

Next, the detection area ybtm will be described. It is assumed that the camera is oriented substantially in the horizontal direction. When the detection distance is Z [cm], the height of the lower half of the image captured by the camera 20 is Z*tan(θ/2) [cm]. On the other hand, in an area lower than the height H1, a face of a viewer can be located in an area of (H1−Ymin) [cm] or less.

Therefore, when the formula (8) below is satisfied as in the case of Z=Zq shown in FIG. 6, a face of a viewer may exist in the entire area of the lower half of the image captured by the camera 20.

H1−Ymin>Z*tan(θ/2) (8)

Therefore, when the detection distance Z satisfies the formula (9) derived from the above formula (8), the detection area setting module 32 sets the entire area of the lower half of the image captured by the camera 20 to the detection area ybtm as shown by the formula (10) below.

Z<(H1−Ymin)/tan(θ/2) (9)

ybtm=hpic/2 (10)

On the other hand, when the above formula (8) is not satisfied as in the case of Z=Zp shown in FIG. 5, the camera 20 captures an image lower than an area in which a face of a viewer can exist. In this case, the area in which a face of a viewer can exist is ybtm [pixels] among the number of pixels hpic/2 [pixels] of the lower half of the image captured by the camera 20. On the other hand, the area in which a face of a viewer can exist is (H1−Ymin) [cm] among the height Z*tan(θ/2) [cm] in which an image is captured by the camera 20. Therefore, the proportional relationship indicated by the formula (11) below is established.

hpic/2:ybtm=Z*tan(θ/2):H1−Ymin (11)

Therefore, if the above formula (8) is not satisfied, the formula (12) below is derived.

$$ybtm = \frac{hpic}{2} * \frac{H 1 - Y min}{Z * tan θ / 2} \qquad ( 12 )$$

In summary, the detection area setting module 32 sets the detection area ybtm as indicated by the formula (13) below.

$$\begin{matrix}ybtm = \frac{hpic}{2} & ( for Z < \frac{H 1 - Y min}{tan θ / 2} ) \\ = \frac{hpic}{2} * \frac{H 1 - Y min}{Z * tan θ / 2} & ( for Z \geq \frac{H 1 - Y min}{tan θ / 2} )\end{matrix} \qquad ( 13 )$$

The detector 31 performs the face detection process within the detection areas ytop and ybtm set as described above.

As described above, in the first embodiment, the detection area in which the face detection process is performed is set according to the distance between the camera 20 and a viewer to be detected. Therefore, the processing load can be reduced.

### Second Embodiment

While the height H1 of the camera 20 from the floor surface is assumed to be known in the first embodiment, in the second embodiment described below, the height H1 is calculated based on the height of a viewer.

FIG. 7 is a diagram for explaining a manner for calculating the height H1. As shown in FIG. 7, the viewer stands up facing the video display apparatus 10. Then, the viewer instructs the face detection apparatus 30 to perform the face detection by using a remote control. In response to this, the detector 31 detects the face of the viewer. The distance Zu (=ave_w*f_{H}/wu) [cm] between the viewer and the video display apparatus 10 is known based on the above formula (1) from the size of the detection window (that is, the horizontal width of the face) wu when the face is detected.

Also, the coordinates (xu, yu) of the center position of the detection window in the image captured by the camera 20 is known ((xu, yu) are coordinates on the image plane). The coordinates (xu, yu) indicates the number of pixels by which the coordinates (xu, yu) is away from the origin which is the center of the image captured by the camera 20. Here, when the length from the center of the detection window to the top of the head is k, the coordinates of the top of the head of the face is (xu, yu+k). For example, it is possible to obtain k by multiplying the size wu of the detection window by a predetermined constant (for example, 0.5).

The detector 31 provides, to the detection area setting module 32, the distance Zu between the viewer and the video display apparatus 10 and the y coordinate (yu+k) of the top of the head of the viewer which are obtained as described above.

Before or after the face detection of the viewer is performed, the viewer inputs the height Hu [cm] of the viewer into the face detection apparatus 30 by using, for example, a remote control.

At this time, the position of the top of the head of the viewer is (yu+k) [pixels] among the number of pixels hpic/2 [pixels] of the upper half of the image captured by the camera 20. On the other hand, the height of the top of the head of the viewer is Hu−H1 among the height Zu*tan(θ/2) [cm] captured by the camera 20. Therefore, the proportional relationship indicated by the formula (14) below is established.

Hu−H1:Zu*tan(θ/2)=yu+k:hpic/2 (14)

Therefore, the detection area setting module 32 can calculate the height H1 of the camera 20 from the floor surface based on the formula (15) below.

$$H 1 = Hu - \frac{2 * ( yu + k ) * Zu * tan θ / 2}{hpic} \qquad ( 15 )$$

The process for calculating the height H1 may be performed once, for example, when the video display apparatus 10 is purchased and installed. The detection area setting module 32 can calculate the detection areas ytop and ybtm based on the above formulas (7) and (13) by using the calculated height H1.

In this way, in the second embodiment, the height H1 of the camera 20 from the floor surface is automatically calculated only by inputting the height of the viewer into the video display apparatus 10 by a viewer. Therefore, it is possible to set the detection area more easily.

### Third Embodiment

The distance or position of the viewer can be specified by the above first or second embodiment. According to the specified distance or position, various processing can be performed. For example, speech processing can be performed so that surround effect due to the sound generated by the speakers of the video display apparatus can be obtained at the position of the viewer. Alternatively, it is possible to perform video processing so that the video is seen stereoscopically at the position of the viewer for a video display apparatus which can display video stereoscopically. In the third embodiment, the latter will be described in detail.

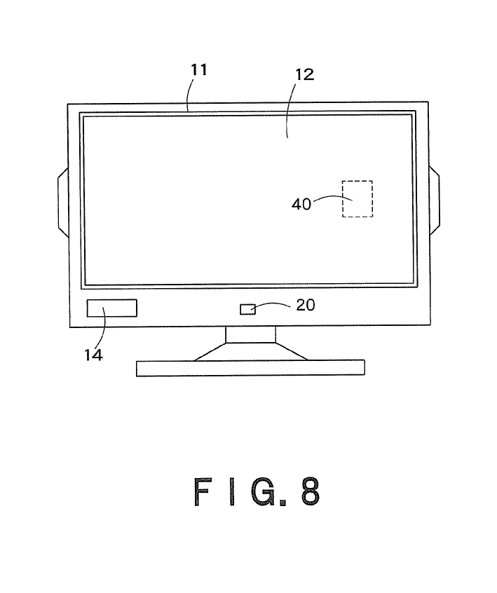

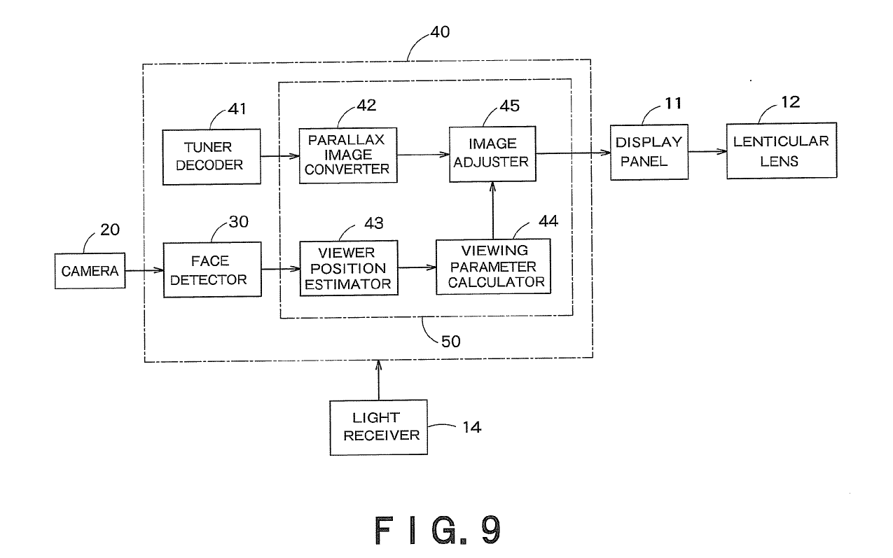

FIG. 8 is an external view of a video display system, and FIG. 9 is a block diagram showing a schematic configuration thereof. The video display system has a display panel 11, a lenticular lens 12, a camera 20, a light receiver 14 and a controller 40.

The display panel 11 displays a plurality of parallax images which can be observed as stereoscopic video by a viewer located in a viewing area. The display panel 11 is, for example, a 55-inch size liquid crystal panel and has 4K2K (3840*2160) pixels. A lenticular lens is obliquely arranged on the display panel 11, so that it is possible to produce an effect corresponding to a liquid crystal panel in which 11520 (=1280*9) pixels in the horizontal direction and 720 pixels in the vertical direction are arranged to stereoscopically display an image. Hereinafter, a model in which the number of pixels in the horizontal direction is extended in this way will be described. In each pixel, three sub-pixels, that is, an R sub-pixel, a G sub-pixel, and a B sub-pixel, are formed in the vertical direction. The display panel 11 is irradiated with light from a backlight device (not shown) provided on a rear surface. Each pixel transmits light with intensity according to an image signal supplied from the controller 40.

The lenticular lens (aperture controller) 12 outputs a plurality of parallax images displayed on the display panel 11 (display unit) in a predetermined direction. The lenticular lens 12 has a plurality of convex portions arranged along the horizontal direction. The number of the convex portions is 1/9 of the number of pixels in the horizontal direction of the display panel 11. The lenticular lens 12 is attached to a surface of the display panel 11 so that one convex portion corresponds to 9 pixels arranged in the horizontal direction. Light passing through each pixel is outputted with directivity from near the apex of the convex portion in a specific direction.

In the description below, an example will be described in which 9 pixels are provided for each convex portion of the lenticular lens 12 and a multi-parallax manner of 9 parallaxes can be employed. In the multi-parallax manner, a first to a ninth parallax images are respectively displayed on the 9 pixels corresponding to each convex portion. The first to the ninth parallax images are images respectively obtained by viewing a subject from nine viewpoints aligned along the horizontal direction of the display panel 11. The viewer can view video stereoscopically by viewing one parallax image among the first to the ninth parallax images with the left eye and viewing another parallax image with the right eye through the lenticular lens 12. According to the multi-parallax manner, the greater the number of parallaxes is, the lager the viewing area is. The viewing area is an area where a viewer can view video stereoscopically when the viewer views the display panel 11 from the front of the display panel 11.

The display panel 11 can display a two-dimensional image by displaying the same color by 9 pixels corresponding to each convex portion.

In the present embodiment, the viewing area can be variably controlled according to a relative positional relationship between a convex portion of the lenticular lens 12 and the parallax images to be displayed, that is, how the parallax images are displayed on the 9 pixels corresponding to each convex portion. Hereinafter, the control of the viewing area will be described.

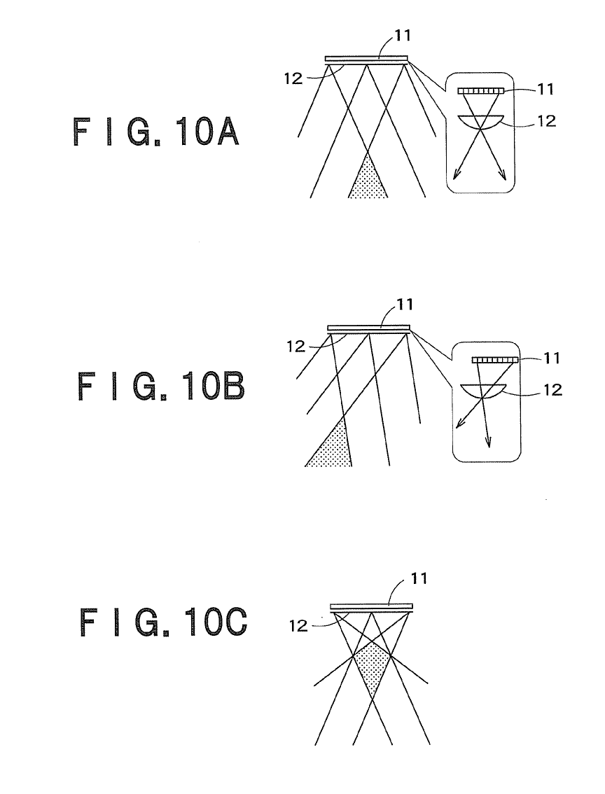

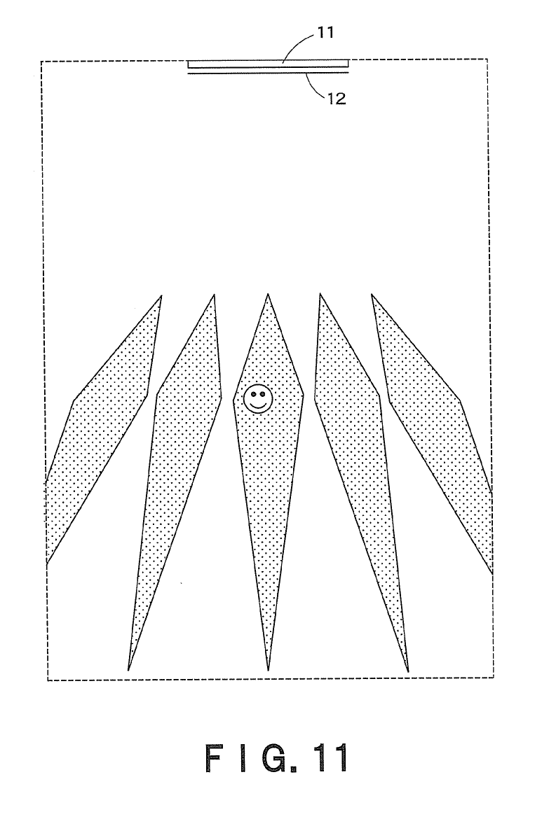

FIG. 10 is a diagram of a part of the display panel 11 and the lenticular lens 12 as seen from above. The shaded areas in FIG. 10 indicate the viewing areas. When the display panel 11 is viewed from a viewing area, video can be viewed stereoscopically. In other areas, reverse view and/or crosstalk occur and video is difficult to be viewed stereoscopically. The nearer to the center of the viewing area the viewer is located, the more the viewer can feel stereoscopic effect. However, even when the viewer is located in the viewing area, if the viewer is located at an edge of the viewing area, the viewer may not feel sufficient stereoscopic effect or the reverse view may occur.

FIG. 10 shows a relative positional relationship between the display panel 11 and the lenticular lens 12, more specifically, a situation in which the viewing area varies depending on a distance between the display panel 11 and the lenticular lens 12, or depending on the amount of shift between the display panel 11 and the lenticular lens 12 in the horizontal direction.

In practice, the lenticular lens 12 is attached to the display panel 11 by accurately positioning the lenticular lens 12 to the display panel 11, and thus, it is difficult to physically change the relative positions of the display panel 11 and the lenticular lens 12.

Therefore, in the present embodiment, display positions of the first to the ninth parallax images displayed on the pixels of the display panel 11 are shifted, so that the relative positional relationship between the display panel 11 and the lenticular lens 12 is changed apparently. Thereby, the viewing area is adjusted.

For example, comparing to a case in which the first to the ninth parallax images are respectively displayed on the 9 pixels corresponding to each convex portion (FIG. 10A), the viewing area moves left when the parallax images are collectively shifted right (FIG. 10B). On the other hand, when the parallax images are collectively shifted left, the viewing area moves right.

When the parallax images are not shifted near the center in the horizontal direction, and the nearer to the outer edge of the display panel 11 the parallax images are located, the larger the parallax images are shifted outward (FIG. 10C), the viewing area moves toward the display panel 11. A pixel between a parallax image that is shifted and a parallax image that is not shifted, and/or a pixel between parallax images that are shifted by different amounts, may be generated by interpolation according to surrounding pixels. Contrary to FIG. 10C, when the parallax images are not shifted near the center in the horizontal direction, and the nearer to the outer edge of the display panel 11 the parallax images are located, the larger the parallax images are shifted toward the center, the viewing area moves outward from the display panel 11.

In this way, by shifting and displaying all the parallax images or a part of the parallax images, the viewing area can be moved in the left-right direction or the front-back direction with respect to the display panel 11. Although only one viewing area is shown in FIG. 10 for the simplicity of the description, actually, there are a plurality of viewing areas in an audience area P and the viewing areas move in conjunction with each other as shown in FIG. 11. The viewing areas are controlled by the controller 40 shown in FIG. 9 described later.

Referring back to FIG. 8, the camera 20 is attached near the lower center position of the display panel 11 at a predetermined elevation angle. The camera 20 takes video in a predetermined range in front of the display panel 11. The taken video is supplied to the controller 40 and used to detect the position of the viewer and the face of the viewer and so on. The camera 20 may take both a moving image and a still image. Furthermore, the camera 20 can be attached at any position and any angle, and at least, the camera 20 takes the video including the viewer viewing the display panel 11 in front of the display panel 11.

The light receiver 14 is provided at, for example, the lower left portion of the display panel 11. The light receiver 14 receives an infrared signal transmitted from a remote control used by the viewer. The infrared signal includes a signal indicating whether to display stereoscopic video or to display two-dimensional video, whether or not to display a menu display. Furthermore, the infrared signal includes a signal for setting the height of the viewer to the face detector 30, as described in the second embodiment.

Next, the details of constituent elements of the controller 40 will be described. As shown in FIG. 9, the controller 40 includes a tuner decoder 41, a parallax image converter 42, a face detector 30, a viewer position estimator 43, a viewing area parameter calculator 44, and an image adjuster 45. The parallax image converter 42, the viewer position estimator 43, the viewing area parameter calculator 44, and the image adjuster 45 form viewing area adjuster 50. The controller 40 is mounted as, for example, one IC (Integrated Circuit) and disposed on the rear surface of the display panel 11. Of course, a part of the controller 40 may be implemented as software.

The tuner decoder (receiver) 41 receives and selects an inputted broadcast wave and decodes a coded input video signal. When a data broadcast signal such as electronic program guide (EPG) is superimposed on the broadcast wave, the tuner decoder 41 extracts the data broadcast signal. Or, the tuner decoder 41 receives a coded input video signal from a video output device such as an optical disk reproducing device and a personal computer instead of the broadcast wave and decodes the coded input video signal. The decoded signal is also called a baseband video signal and supplied to the parallax image converter 42. When the video display device 100 receives no broadcast wave and exclusively displays the input video signal received from the video output device, a decoder having only a decoding function may be provided instead of the tuner decoder 41 as a receiver.

The input video signal received by the tuner decoder 41 may be a two-dimensional video signal or a three-dimensional video signal including images for the left eye and the right by a frame-packing (FP) manner, a side-by-side (SBS) manner, a top-and-bottom (TAB) manner, or the like. The video signal may be a three-dimensional video signal including an image of three or more parallaxes.

The parallax image converter 42 converts the baseband video signal into a plurality of parallax image signals in order to display video stereoscopically. The process of the parallax image converter 42 depends on whether the baseband signal is a two-dimensional video signal or a three-dimensional video signal.

When a two-dimensional video signal or a three-dimensional video signal including an image of eight or less parallaxes is inputted, the parallax image converter 42 generates the first to the ninth parallax image signals on the basis of depth value of each pixel in the video signal. A depth value is a value indicating how much near-side or far-side of the display panel 11 each pixel is seen. The depth value may be added to the input video signal in advance or the depth value may be generated by performing motion detection, composition recognition, human face detection, and the like on the basis of characteristics of the input video signal. On the other hand, when a three-dimensional video signal including an image of 9 parallaxes is inputted, the parallax image converter 42 generates the first to the ninth parallax image signals by using the video signal.

The parallax image signals of the input video signal generated in this way is supplied to the image adjuster 45.

The face detector 30 is a face detection apparatus 30 described in the first or second embodiment, and searches the viewer within a search range which is whole or a part of the image captured by the camera 20. According to this, the distance Z between the video display apparatus 10 and the viewer, and the center position coordinates (x, y) of the detection window when the face is detected, are outputted and supplied to the viewer position estimator 43.

The viewer position estimator 43 estimates viewer's position information in the real space based on the processing result of the face detector 30. The viewer's position information is represented as positions on X axis (horizontal direction) and Y axis (vertical direction), whose origins are on the center of the display panel 11, for example.

The viewing area parameter calculator 44 calculates a viewing area parameter for setting a viewing area that accommodates the detected viewer by using the position information of the viewer supplied from the viewer position estimator 43. The viewing area parameter is, for example, the amount by which the parallax images are shifted as described in FIG. 10. The viewing area parameter is one parameter or a combination of a plurality of parameters. The viewing area parameter calculator 44 supplies the calculated viewing area parameter to the image adjuster 45.

The image adjuster (viewing area controller) 45 performs adjustment such as shifting and interpolating the parallax image signals according to the calculated viewing area parameter in order to control the viewing area when the stereoscopic video is displayed on the display panel 11.

As stated above, in the third embodiment, the viewing area can be set at the position of the viewer with decreased processing amount.

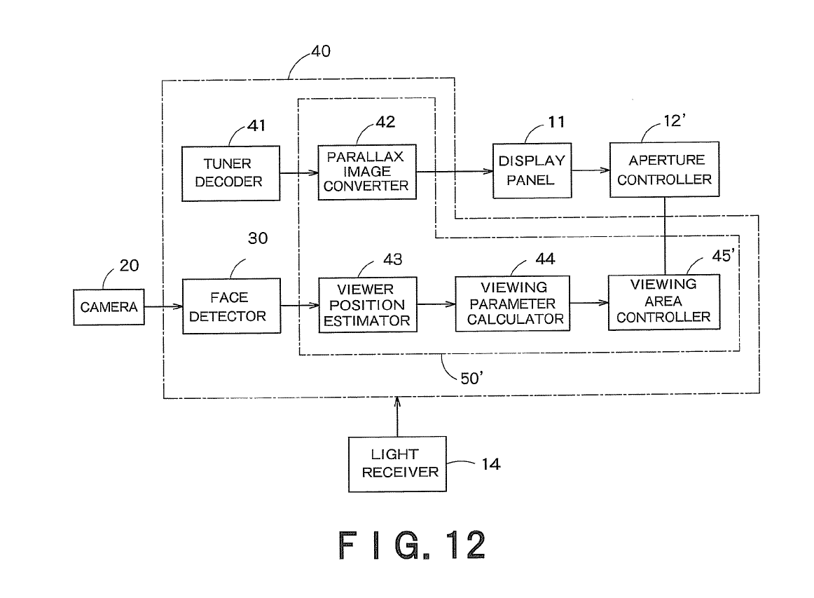

Although, in the third embodiment, an example is described in which the lenticular lens 12 is used and the viewing area is controlled by shifting the parallax images, the viewing area may be controlled by other manners. For example, instead of the lenticular lens 12, a parallax barrier may be provided as an aperture controller 12′. FIG. 12 is a block diagram showing a schematic configuration of the video display system which is a modified example of the embodiments shown in FIG. 9. As shown in FIG. 12, the controller 40′ of the video display device 100′ has the viewing area controller 45′ instead of the image adjuster 45.

The viewing area controller 45′ controls the aperture controller 12′ according to the viewing area parameter calculated by the viewing area information calculator 15. In the present modified example, the viewing area parameter includes a distance between the display panel 11 and the aperture controller 12′, the amount of shift between the display panel 11 and the aperture controller 12′ in the horizontal direction, and the like.

In the present modified example, the output direction of the parallax images displayed on the display panel 11 is controlled by the aperture controller 12′, so that the viewing area is controlled. In this way, the viewing area controller 16′ may control the aperture controller 12′ without performing a process for shifting the parallax images.

At least a part of the video display system explained in the above embodiments can be formed of hardware or software. When the video display system is partially formed of the software, it is possible to store a program implementing at least a partial function of the video display system in a recording medium such as a flexible disc, CD-ROM, etc. and to execute the program by making a computer read the program. The recording medium is not limited to a removable medium such as a magnetic disk, optical disk, etc., and can be a fixed-type recording medium such as a hard disk device, memory, etc.

Further, a program realizing at least a partial function of the video display system can be distributed through a communication line (including radio communication) such as the Internet etc. Furthermore, the program which is encrypted, modulated, or compressed can be distributed through a wired line or a radio link such as the Internet etc. or through the recording medium storing the program.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. A detection apparatus comprising:
a detector configured to detect a human face within a detection area, the detection area comprising a part of or a whole of an image captured by a camera, wherein the human face to be detected is at a distance from the camera; and
a detection area setting module configured to set the detection area narrower as the distance becomes longer.

2. The apparatus of claim 1, wherein the detector is configured to, by varying a detection window corresponding to the distance, detect the human face, wherein a size of the human face depends on the detection window, and
the detection area setting module is configured to set the detection area narrower as the detection window is made smaller.

3. The apparatus of claim 1, wherein the detection area setting module is configured to:
set a whole of an upper half of the image captured by the camera as the detection area when the distance is smaller than a first value, and
set a part of the upper half of the image captured by the camera as the detection area when the distance is equal to or larger than the first value.

4. The apparatus of claim 1, wherein the detection area setting module is configured to:
set a whole of a lower half of the image captured by the camera as the detection area when the distance is smaller than a second value, and
set a part of the lower half of the image captured by the camera as the detection area when the distance is equal to or larger than the second value.

5. The apparatus of claim 1, wherein the camera is attached on a video display apparatus comprising a display, and
the detector is configured to detect the face of a viewer viewing the display.

6. The apparatus of claim 5, wherein the detection area setting module is configured to set a part of or a whole of an upper half of the image captured by the camera based on a maximum value of a height where the face of the viewer exists.

7. The apparatus of claim 5, wherein the detection area setting module is configured to set a part of or a whole of a lower half of the image captured by the camera based on a minimum value of a height where the face of the viewer exists.

8. The apparatus of claim 5, wherein the camera is attached substantially toward a horizontal direction on the video display apparatus, and
the detection area setting module is configured to set the detection area based on following equations (1) and (2),
$$\begin{matrix}\begin{matrix}ytop = \frac{hpic}{2} & ( for Z < \frac{Y max - H 1}{tan ( θ / 2 )} ) \\ = \frac{hpic}{2} * \frac{Y max - H 1}{Z * tan θ / 2} & ( for Z \geq \frac{Y max - H 1}{tan ( θ / 2 )} )\end{matrix} & ( 1 ) \\ \begin{matrix}ybtm = \frac{hpic}{2} & ( for Z < \frac{H 1 - Y min}{tan ( θ / 2 )} ) \\ = \frac{hpic}{2} * \frac{H 1 - Y min}{Z * tan θ / 2} & ( for Z \geq \frac{H 1 - Y min}{tan ( θ / 2 )} )\end{matrix} & ( 2 )\end{matrix}$$
where the ytop is a first number of pixels in the detection area in an upper half of the image captured by the camera,
the ybtm is a second number of pixels in the detection area in a lower half of the image captured by the camera,
the hpic is a third number of pixels in a vertical direction of the image captured by the camera,
the Ymax is a maximum value of a first height, where the face of the viewer exists, from a first surface,
the Ymin is a minimum value of a second height, where the face of the viewer exists, from the first surface,
the H1 is a third height of the camera from the first surface, and
the θ is a field angle of a vertical direction of the camera.

9. The apparatus of claim 5, wherein the viewer is on a first surface, and
the detection area setting module is configured to set the detection area taking a height of the camera from the first surface into consideration.

10. The apparatus of claim 9, wherein the detector is configured to detect a distance between the viewer and the camera, and
the detection area setting module is configured to calculate the height of the camera from the first surface based on a body height of the viewer and the distance between the viewer and the camera.

11. The apparatus of claim 10, wherein the detection area setting module is configured to calculate the height of the camera from the first surface based on a following equation (3)
$$H 1 = Hu - \frac{2 * ( yu + k ) * Zu * tan ( θ / 2 )}{hpic} \qquad ( 3 )$$
where the H1 is the height of the camera from the first surface,
the Hu is the body height of the viewer,
the yu is a vertical direction position of the face of the viewer in the image captured by the camera,
the k is a value depending on the distance between the viewer and the camera,
the Zu is the distance between the viewer and the camera,
the θ is a field angle of a vertical direction of the camera, and
the hpic is a first number of pixels in a vertical direction of the image captured by the camera.

12. A detection apparatus comprising:
a detector configured to detect a human face within a detection area which is a part of or a whole of an image captured by a camera, by varying a detection window; and
a detection area setting module configured to set the detection area narrower as the detection window is smaller.

13. A video display system comprising:
a camera;
a display configured to display a video;
a detector configured to detect a face of a viewer within a detection area, the detection area comprising a part of or a whole of an image captured by a camera, wherein the face of the viewer to be detected is at a distance from the camera, the display configured to display the video to the viewer for viewing; and
a detection area setting module configured to set the detection area narrower as the distance becomes longer.

14. The system of claim 13, wherein the display is capable of displaying a stereoscopic video, and
the system further comprises a viewing area controller configured to set a viewing area at a position of the detected face, the video configured to be seen stereoscopically from the viewing area.

15. A detection method comprising:
detecting a human face within a detection area, the detection area comprising a part of or a whole of an image captured by a camera, wherein the human face to be detected is at a distance from the camera; and
setting the detection area narrower as the distance becomes longer.
